(19) United States
(12) Patent Application Publication
(10) Pub. No.: US 2010/0300595 A1
(43) Pub. Date: Dec. 2, 2010

(54) PNEUMATIC TIRE WITH AN OVERLAY REINFORCEMENT

(76) Inventors: Serge Julien Auguste Imhoff, Schrondweiler (LU); Yves Donckels, Natove (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/423,944

(22) Filed: Jun. 1, 2009

(51) Int. Cl. B60C 9/18

(52) U.S. Cl. 152/527

(57) ABSTRACT

A pneumatic tire includes a radial ply carcass, a tread portion disposed radially outward of the carcass, and a crown reinforcing structure interposed between the tread portion and the carcass in circumferential relation to the carcass. The crown reinforcing structure includes a belt assembly having at least one belt ply with reinforcement cords extending parallel to one another and an overlay structure including a nylon reinforced layer extending transversely over the belt assembly and making an angle of between −5 degrees and +5 degrees with an equatorial plane of the tire. The nylon reinforced layer includes nylon cords having a 2000-2200/1 Dtex, 1-10 TPI construction with an end density of 10-35 EPI.

### FIELD OF THE INVENTION

The present invention relates generally to pneumatic tires and more specifically to radial carcass tires having a textile overlay structure located radially outwardly of the belt assembly.

### BACKGROUND OF THE INVENTION

Conventional radial carcass tires have a reinforcing member disposed radially outwardly of the belt assembly. The reinforcing member may comprise textile cords oriented at small angles with respect to the mid-circumferential plane of the tire. Such a reinforcing member has been found to be acceptably durable when subjected to high revolution speeds.

Such a reinforcing member, referred to as an overlay ply, may be interposed between the radially outermost ply of the belt assembly and the tread and comprise one or more wraps having a width which is about equal to that of the widest of the belt plies. Alternatively, the overlay ply may consist of two separate axially spaced apart ply portions either disposed radially outwardly of the belt assembly such as to cover the edges of the radially outermost belt ply or interposed between the belt plies such as to extend between the edges thereof.

Another alternative for an overlay ply consists in interposing a helically wound cord or single yarn, which has been coated with elastomeric material, between the radially outermost ply of the belt assembly and the tread. As winding a single cord is time consuming, conventionally an overlay ply is assembled from a 5 mm to 30 mm wide, helically wound strip, made from cord reinforced elastomeric material, located radially outwardly to the belt plies. The conventional overlay reinforcing material is nylon, which has a Youngs modulus of about 6,000 MPa. Such a low modulus allows expansion of the belt during the shaping and vulcanizing steps of the tire.

It would be desirable to more inexpensively provide a pneumatic tire with an overlay structure having excellent high speed properties, good comfort and rolling resistance, reduced flatspotting, and low noise propagation.

### SUMMARY OF THE INVENTION

A pneumatic tire in accordance with the present invention includes a radial ply carcass, a tread portion disposed radially outward of the carcass, and a crown reinforcing structure interposed between the tread portion and the carcass in circumferential relation to the carcass. The crown reinforcing structure includes a belt assembly having at least one belt ply with reinforcement cords extending parallel to one another and an overlay structure including a nylon reinforced layer extending transversely over the belt assembly and making an angle of between −5 degrees and 5 degrees with an equatorial plane of the tire. The nylon reinforced layer includes nylon cords having a 2000-2200/1 Dtex, 1-10 (S or Z) TPI construction with an end density of 10-35 EPI.

In accordance with another aspect of the present invention, the overlay structure has two layers with a second layer located adjacent to, and radially outside of, a first layer.

In accordance with still another aspect of the present invention, the overlay layer includes a strip with a width in the range of between 5 mm and 30 mm.

### Definitions

The following definitions are controlling for the disclosed invention.

“Apex” means an elastomeric filler located radially above the bead core and between the plies and the turnup ply.

“Annular” means formed like a ring.

“Aspect ratio” of the tire means the ratio of its section height (SH) to its section width (SW) multiplied by 100% for expression as percentage.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Chafers” refers to narrow strips of material placed around the outside of the bead to protect cord plies from the rim, distribute flexing above the rim, and to seal the tire.

“Chippers” means a reinforcement structure located in the bead portion of the tire.

“Circumferential” means lines or directions extending along the perimeter of the surface of the annular tire parallel to the Equatorial Plane (EP) and perpendicular to the axial direction.

“Cord” means one of the reinforcement strands of which the plies of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density). Dtex means the weight in grams per 10,000 meters.

“Elastomer” means a resilient material capable of recovering size and shape after deformation.

“Equatorial plane (EP)” means the plane perpendicular to the tire's axis of rotation and passing through the center of its tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” means a reinforced fabric wrapped about the bead core.

“Greige” means unfinished cord or fabric.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Merged cord” means a cord constructed by helically twisting a plurality of individual yarns, at least one of the individual yarns being of a material different from the material of at least one of the other individual yarns.

“Ply” means a continuous layer of rubber-coated parallel cords in the context of a tire and also means a twisted yarn in a context of a yarn or a cord as used herein the meaning is dependant on the context.

“Polyester” means any polymer synthesized from the polycondensation of a diol and a dicarboxylic acid.

“Radial” and “radially” are used to mean directions radially toward or away from the axis of rotation of the tire.

“Radial-ply tire” means a belted or circumferentially-restricted pneumatic tire in which the ply cords which extend from bead to bead are laid at cord angles between 65 degree and 90 degree with respect to the equatorial plane of the tire.

“Section height (SH)” means the radial distance from the nominal rim diameter of the tire at its equatorial plane.

“Sidewall” means that portion of a tire between the tread and the bead.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Tread” means a molded rubber component which, when bonded to a tire casing, includes that portion of the tire that comes into contact with the road when the tire is normally inflated and under normal load.

“Twisted,” means the number of turns about its axis per unit of length of a yarn, turns per inch being TPI.

“Yarn” occurs in the following forms: 1) a number of fibers twisted together; 2) a number of filaments laid together without twist; 3) a number of filaments laid together with a degree of twist: 4) a single filament with or without twist (monofilament); 5) a narrow strip of material with or without twist.

### BRIEF DESCRIPTION OF THE DRAWINGS

To acquaint persons skilled in the art most closely related to the instant invention, certain example embodiments thereof are now described with reference to the annexed drawings. These example embodiments are illustrative and can be modified in numerous ways within the spirit and scope of the invention as defined in the claims herebelow.

FIG. 1 is a cross-sectional view of a pneumatic tire for use with the present invention.

### DETAILED DESCRIPTION OF AN EXAMPLE OF THE PRESENT INVENTION

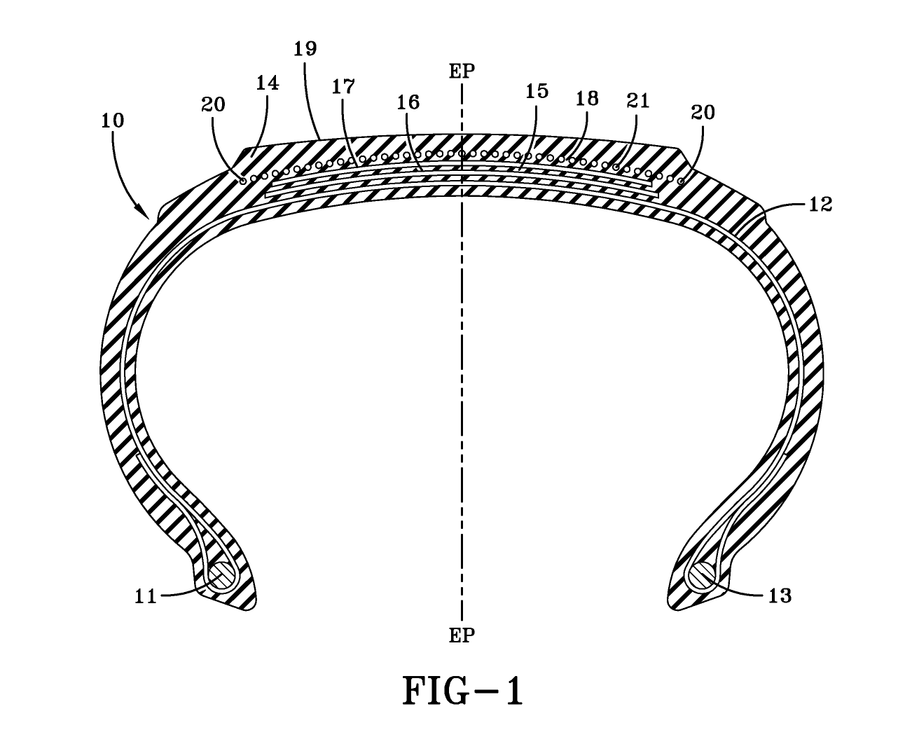

With reference to FIG. 1, there is represented an example radial carcass pneumatic tire 10 having a pair of substantially inextensible bead cores 11, 13 which are axially spaced apart with a radial carcass ply 12 extending between the bead cores. The carcass ply 12 is folded axially and radially outwardly about each of the bead cores 11, 13 and is reinforced by cords which are substantially parallel to each other and make an angle with the equatorial plane (EP) of the example tire 10.

As used herein, the “equatorial plane” of the example tire 10 is a plane that is perpendicular to the axis of rotation of the tire and passes through the center of the tire tread 19. The terms “axial” and “axially” refer to directions which are parallel to the axis of rotation of the example tire 10 and the terms “radial” and “radially” refer to directions that are radially toward or away from the axis of rotation of the tire.

The cords of the carcass ply 12 can be made of any suitable material, for example rayon, polyester, polyamide, or aromatic polyamide. The crown area 14 of the tire 10 is reinforced by a belt assembly 15 located radially inwardly of the tire tread 19. The belt assembly 15 may comprise two concentric belt plies 16, 17, each of which consists of an elastomeric layer reinforced by steel cords or other suitable materials, for example aromatic polyamide, glassfiber, PVA, carbon-fiber, or rayon cords. Within each belt ply 16, 17, the cords may be substantially parallel to each other. The cords of the radially innermost belt ply 16 form an angle of between 15 degrees to 30 degrees with the equatorial plane (EP) of the tire 10. Whereas, the cords of the radially outermost belt ply 17 extend in the diagonally opposite direction to the cords of the radially innermost belt ply 16 and form an angle of between −15 degrees to −30 degrees with the equatorial plane (EP) of the tire 10.

In a cord, each of the yarns has its component filaments twisted together a given number of turns per unit of length of the yarn (usually expressed in TPI) and additionally the yarns are twisted together a given number of turns per unit of length of the cord. The direction of twist refers to the direction of slope of the spirals of a yarn or cord when it is held vertically. If the slope of the spirals conforms in direction to the slope of the letter “S.” then the twist is called “S” or “left hand.” If the slope of the spirals conforms in direction to the slope of the letter “Z.” then the twist is called “Z” or “right hand.” An “S” or “left hand” twist direction is understood to be an opposite direction from a “Z” or “right hand” twist. “Yarn twist” is understood to mean the twist imparted to a yarn before the yarn is incorporated into a cord, and “cord twist” is understood to mean the twist imparted to two or more yarns when they are twisted together with one another to form a cord. “Dtex” is understood to mean the weight in grams of 10,000 meters of a yarn before the yarn has a twist imparted thereto.

A helically wound strip, forming an overlay layer 18, may be superimposed radially, external to the outermost belt ply 17 and may extend transversely over the axially widest portion of the belt plies 16, 17. The helically wound strip may be made from elastomeric material reinforced hybrid organic cords such as nylon. Nylon is understood to be an aliphatic polyamide 6, 4.6, or 6.6.

Conventional reinforcements for overlays have utilized a “by one” nylon construction such as 940/1 Dtex 4.6S TPI (“twist per inch”) or 1400/1 Dtex 4.6S TPI as a cost-effective option. Indeed, a “by one” construction with a low twist and corresponding high modulus may control tire growth, limit standing waves, and achieve a good high speed performance.

However, such “by one” constructions do not achieve certain high speed requirements for high performance tires. Thus, conventional “by two” constructions such as 1400/2 Dtex 6/6 TPI, 1400/2 Dtex 8/8 TPI, or 1400/2 10/10 TPI have been implemented for such high speed requirements.

It would be desirable to utilize a “by one” construction for an overlay which could effectively replace the conventional “by two” constructions, which are more costly to produce and exhibit usually lower modulus. In accordance with the present invention, an overlay ply for a high performance tire may have nylon reinforcement cords with a unique construction of 2000-2200/1 Dtex with a 1-10 TPI twist (S or Z). Additionally, in accordance with the present invention, another overlay ply for a high performance tire may have nylon reinforcement cords with a unique construction of 2400-2600/1 Dtex with a 1-10 TPI twist (S or Z). Furthermore, in accordance with the present invention, still another overlay ply for a high performance tire may have nylon reinforcement cords with a unique construction of 2700-2900/1 Dtex with a 1-10 TPI twist (S or Z). The overlay ply may further exhibit 10-35 EPI (“ends per inch”) of such cords. Such an overlay ply may provide a cost efficient fabric construction while still achieving equal to better high speed performance compared to conventional 1400/2 Dtex constructions.

Further, the simpler construction of the overlay ply in accordance with the present invention may allow reduction of fabric production time and cost due to higher Dtex yarn being cheaper than lower Dtex yarn. Also, the higher modulus of the 2000-2200/1 Dtex overlay ply construction in accordance with the present invention may provide better high speed performance and less “flatspotting” than the conventional 1400/2 Dtex constructions.

The below table expresses a comparison of the tensile characteristics of a 2100/1 Dtex 4.6S TPI overlay cord construction of the present invention and three other constructions. As the table illustrates, the 2100/1 Dtex 4.6S TPI construction of the present invention provides acceptable tensile characteristics compared with the conventional 1400/2 Dtex 6/6 TPI cord construction while being much less expensive to produce. Further, while the 2800/1 Dtex 4.6S TPI construction, another construction in accordance with the present invention, has more desirable tensile characteristics, it is significantly more expensive than the 2100/1 Dtex 4.6S TPI construction. Additionally, a 2500/1 Dtex 1-10 (S or Z) TPI construction in accordance with the present invention desirably yield tensile characteristics superior to the 2100/1 Dtex 4.6S TPI construction while being less expensive than the 2800/1 Dtex 4.6S TPI construction.

| | 1400/2 | 1400/1 | 2800/1 | 2100/1 |
|---|---|---|---|---|
| TWIST | 6/6 | 4.6 | 4.6 | 4.6 |
| Breaking Strength (N) | 231.9 | 124.2 | 243.4 | 176.2 |
| Elongation at break (%) | 17 | 16.2 | 18.1 | 18.2 |
| Lase @ 1% (N) | 14.6 | 8.5 | 16.9 | 13.6 |
| Lase @ 2% (N) | 25.2 | 13.9 | 27.5 | 22.6 |
| Lase @ 3% (N) | 32.5 | 18.6 | 35.2 | 29.3 |
| Lase @ 4% (N) | 40.9 | 24.3 | 44.8 | 37.6 |
| Lase @ 5% (N) | 52 | 31.6 | 57.3 | 48.5 |
| Lase @ 6% (N) | 65.8 | 40.6 | 72.9 | 61.7 |
| Lase @ 7% (N) | 82.2 | 51.4 | 91.1 | 76.8 |
| Lase @ 8% (N) | 101.1 | 63.7 | 111.8 | 93 |
| Lase @ 9% (N) | 121.8 | 77 | 134.1 | 109 |
| Lase @ 10% (N) | 143.4 | 90.2 | 156.7 | 123.5 |

In a tire, such as the example tire 10, the nylon reinforced helically wound overlay 18 in accordance with the present invention may be superimposed externally on the outermost belt ply 17. The helically wound overlay structure 18 may overlap the lateral ends of the radially outermost belt ply 17 by a few millimeters and may provide rigidity in the circumferential direction, as well as a uniform pressure distribution on the tread surface. Although the overlay structure 18 described above one layer, it could equally comprise a second layer located adjacent to and radially outside of the first layer. The second layer may have its helical convolutions wound with the opposite hand to the first layer so that the nylon cords of each layer cross at a very small angle. With such a construction, the two layers may be wound continuously in succession without a break in the strip. The helical convolutions of the helically wound strip, in place of being in abutment with any adjacent convolution, may also have an overlapping relationship with the previous convolutions, which overlap may be constant or variable across the width of the belt reinforcing structure 15 without departing from the spirit of the instant invention.

Further, it is well known that helical convolutions of a tire built on a flat cylindrical drum are subjected to different elongations during the shaping and vulcanizing step of the tire manufacturing process because the expansion of the tire is greater in the center portion than in the shoulder portions of the belt reinforcing structure. In order to minimize the resulting differences in the stresses of the strip, the strip in the belt center may be wound with a very small winding tension as compared to the winding tension used when making the tire shoulder portion of the strip.

Alternatively, the surface of the cylindrical drum upon which the strip is helically wound may be given a slightly convex shape. This convex shape may conform as closely as possible to the sectional radial shape the overlay ply 18 may take in the finished tire, so as to obtain a minimal stretch difference between the center and shoulder portions of the overlay strip during shaping and curing.

An uncured radial tire undergoes an expansion of about three percent during the shaping in the tire mold. This shaping effects a pantographing of the cords of the belt plies, and a pretension to the cords reinforcing the carcass ply or plies as far as these cords cannot slide around the bead cores. The nylon cords reinforcing the helically wound overlay of the example tire may also be pretensioned during the shaping operation and by adequately choosing an uncured tire dimension and mold shape. It is understood that a curing temperature of 160° C. to 200° C. may effect a slight shrinking of the nylon cords only, which effect comes in addition to the shaping.

The above results clearly demonstrate the excellent high speed performance of tires manufactured according to the teaching of the present invention. While a particular form of the present invention has been illustrated and described, it will also be apparent to those skilled in the art that various modifications can be made without departing from the spirit and scope of the invention. Accordingly, it is not intended that the invention be limited in any way except by the appended claims.

What is claimed is:

1. A pneumatic tire comprising a radial ply carcass, a tread disposed radially outward of the carcass and a crown reinforcing structure interposed between the tread portion and the carcass in circumferential relation to the carcass, the crown reinforcing structure including a belt assembly having at least one belt ply with reinforcement cords extending parallel to one another and an overlay structure including a nylon reinforced layer extending transversely over the belt assembly and making an angle of between −5 degrees and +5 degrees with an equatorial plane of the tire, the nylon reinforced layer including nylon cords having a 2000-2200/1 Dtex, 1-10 TPI construction with an end density of 10-35 EPI.

2. A pneumatic tire as set forth in claim 1 wherein the overlay structure has two layers with a second layer located adjacent to, and radially outside of, a first layer.

3. A pneumatic tire as set forth in claim 1 wherein the overlay layer includes a strip with a width in the range of between 5 mm and 30 mm.

4. A pneumatic tire comprising a radial ply carcass, a tread disposed radially outward of the carcass and a crown reinforcing structure interposed between the tread portion and the carcass in circumferential relation to the carcass, the crown reinforcing structure including a belt assembly having at least one belt ply with reinforcement cords extending parallel to one another and an overlay structure including a nylon reinforced layer extending transversely over the belt assembly and making an angle of between −5 degrees and +5 degrees with an equatorial plane of the tire, the nylon reinforced layer including nylon cords having a 2400-2600/1 Dtex, 1-10 TPI construction with an end density of 10-35 EPI.

5. A pneumatic tire comprising a radial ply carcass, a tread disposed radially outward of the carcass and a crown reinforcing structure interposed between the tread portion and the carcass in circumferential relation to the carcass, the crown reinforcing structure including a belt assembly having at least one belt ply with reinforcement cords extending parallel to one another and an overlay structure including a nylon reinforced layer extending transversely over the belt assembly and making an angle of between −5 degrees and +5 degrees with an equatorial plane of the tire, the nylon reinforced layer including nylon cords having a 2700-2900/1 Dtex, 1-10 TPI construction with an end density of 10-35 EPI.
